(19) United States
(12) Patent Application Publication
(10) Pub. No.: US 2008/0186284 A1
(43) Pub. Date: Aug. 7, 2008

(54) Dual-mode touch input apparatus and mode-switching method for the same

(75) Inventors: Ching-Sung Chang, Taipei (TW); Sea-Weng Young, Taipei (TW)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/806,635

(22) Filed: Jun. 1, 2007

(30) Foreign Application Priority Data
Feb. 2, 2007 (TW) 96103955

(51) Int. Cl. G06F 3/041

(52) U.S. Cl. 345/173

(57) ABSTRACT

A dual-mode touch input apparatus, mounted in an electronic apparatus and capable of arbitrarily switching around a 1-D input mode and a 2-D input mode, comprises a touch pad, a flexible printed circuit board (FPCB) and a control chip. The FPCB is used for detecting a position of a user touch and issuing a detection signal to the control chip. The control chip is used for determining whether the dual-mode touch input apparatus is at the 1-D input mode or the 2-D input mode and producing a cursor signal in response to the user touch to control movement of a cursor on a screen of the electronic apparatus.

This application claims the benefit of Taiwan Patent Application Serial No. 96103955, filed Feb. 2, 2007, the subject matter of which is incorporated herein by reference.

### BACKGROUND OF THE INVENTION

(1) Field of the Invention

The invention relates to a touch input apparatus, and more particularly to a dual-mode touch input apparatus that can operate between a 1-D input mode and a 2-D input mode.

(2) Description of the Prior Art

Applications of mouse devices, directional/non-directional touch input devices and the like index input devices are widely used with the electronic apparatuses in the marketplace, such as computers, personal digital assistants, and the like apparatuses.

Referred to FIG. 1, a typical mouse device is perspective shown. The mouse 1 includes a left button 10, a right button 12 and a flywheel 14. The mouse 1 can be moved on a plane in a 2-D pattern so as to control movement of a cursor on a screen of the electronic apparatus. The operation of the mouse 1 can be preset by the user. For example, the user can set “double clicking the left button 10” to stand for a determination, “clicking once the left button 10” to stand for a selection, and “clicking once the right button 12” to stand for popping up available functional options. The flywheel 14 is usually used to scroll the screen, without moving the cursor.

Though the mouse 1 can provide a handy tool to move the cursor, yet a substantial planar area is required for its operation. Also, the storage of the mouse 1 needs some space. Those limitations make the application of the mouse device inconvenient to some desk-top computers and most of the portable computers.

In the art, the touch input apparatus, whether it is a resistor type, a electromagnetic type, or an inducing type, mainly includes a touch pad (a plastic membrane) and a flexible printed circuit board (FPCB). When a user has his/her finger touch the touch pad, a relevant voltage change would be produced to be further realized by a processor of the electronic apparatus so as to generate a corresponding control on the screen.

Referred to FIG. 2, a conventional electronic apparatus having a directional touch input device is shown. The directional touch input device 22 (represented by a touch wheel as shown) provides a 1-D moving control on a screen 20 of the apparatus 2. By turning the touch wheel 22, the screen 20 or the option list on the screen 20 can be scrolled up and down accordingly.

On the other hand, the non-directional touch input apparatus such as the touch pad device can provide a 2-D cursor control. When the user has his/her finger move on the touch pad, the cursor on the screen of the electronic apparatus would moved accordingly.

Though the operation of the touch input apparatus needs only a pretty limited space and no additional storage room is required, yet some disadvantages in usage still exist. One of those disadvantages is that, by finger controlling on the touch pad, the cursor on the screen is hard to be precisely located to the tiny scroll control bar. Inevitably, reciprocal back-and-forth finger movements on the touch pad will be expected for correctly controlling the cursor on the screen. Further, because the touch pad is a planar structure, the finger feeling of a real touch on the touch pad is usually too slight to be distinguished. In practice, careless multiple clicking, overtime depressing, and ghost touching are usually seen in the application of the touch pad apparatus.

Therefore, a resort to resolve the aforesaid ill-control problem in cursor movement of the touch input apparatus and also to integrate the merits of the touch wheel into the touch input apparatus is definitely welcome to the skilled persons in the art.

### SUMMARY OF THE INVENTION

Accordingly, it is an object of the present invention to provide a dual-mode touch input apparatus that can facilitate both the 1-D input control and a 2-D input control by adopting relevant program change.

It is another object of the present invention to provide a mode-switching method for the dual-mode touch input apparatus to come true the dual-mode control in operations of the apparatus.

In the present invention, the dual-mode touch input apparatus is mounted in an electronic apparatus and can be arbitrarily switched to operate between a 1-D input mode and a 2-D input mode. The dual-mode touch input apparatus comprises a touch pad, a flexible printed circuit board (FPCB) and a control chip. The touch pad is performed as an interface between the dual-mode touch input apparatus and its user. The FPCB further has a plurality of sensors, is located under the touch pad, and is used for detecting a position of a user touch and issuing a detection signal. The control chip is used for receiving the detection signal from the FPCB, determining whether the dual-mode touch input apparatus is at the 1-D input mode or the 2-D input mode, and producing a cursor signal in response to the user touch to control movement of a cursor on a screen of the electronic apparatus.

In the present invention, the mode-switching method for the dual-mode touch input apparatus comprises the steps of: the FPCB detecting a detection signal and further forwarding the detection signal to the control chip; the control chip receiving the detection signal and initiating the dual-mode touch input apparatus at the 2-D input mode; the control chip receiving a switch signal and then switching the dual-mode touch input apparatus to the 1-D input mode; detecting a direction signal and scrolling upward the screen of the electronic apparatus if the direction signal is a positive signal; and scrolling downward the screen if the direction signal is a negative signal.

All these objects are achieved by the dual-mode touch input apparatus and the mode switching method for the same apparatus described below.

### BRIEF DESCRIPTION OF THE DRAWINGS

The present invention will now be specified with reference to its preferred embodiment illustrated in the drawings, in which:

FIG. 1 is a perspective view of a conventional mouse device;

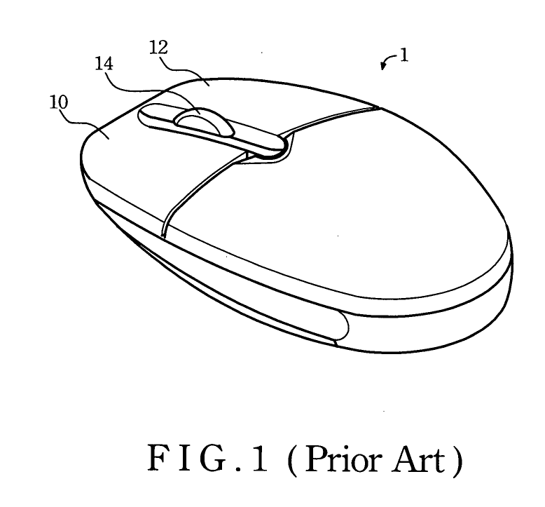

FIG. 2 is a perspective view of a conventional electronic apparatus with a directional touch input device;

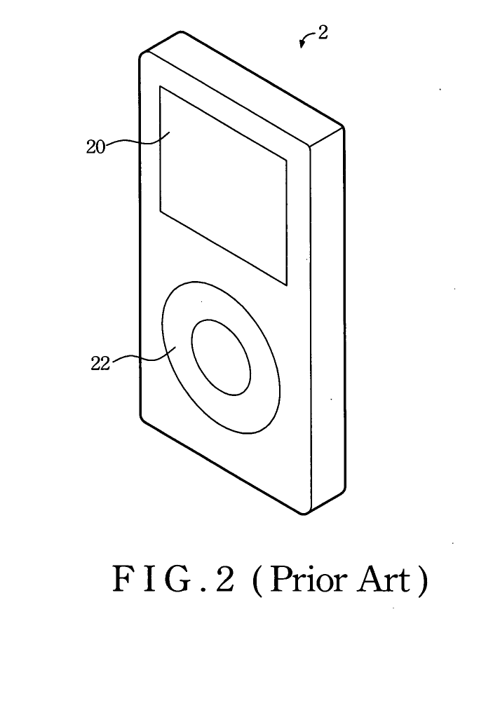

FIG. 3 is a flowchart of a preferred mode-switching method for a preferred dual-mode touch input apparatus in accordance with the present invention; and

FIG. 4 is a front view and a top view of the touch pad and the flexible printed circuit board of the preferred dual-mode touch input apparatus in accordance with the present invention.

### DESCRIPTION OF THE PREFERRED EMBODIMENT

The invention disclosed herein is directed to a dual-mode touch input apparatus and a mode-switching method for the same apparatus. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In the present invention, the dual-mode touch input apparatus, resembled to most of the touch pad devices already existing in the marketplace, is mounted inside or with an electronic apparatus. By adopting appropriate control change as described below, any conventional touch pad device can be transformed into a touch pad for the dual-mode touch input apparatus in accordance with the present invention. That is to say, any conventional touch pad can be upgraded to be the touch pad for the present dual-mode touch input apparatus that can perform a 1-D input mode and a 2-D input mode.

In the present invention, the preferred dual-mode touch input apparatus comprises a touch pad, a flexible printed circuit board (FPCB), a function key, and a control chip. The touch pad is performed as an interface between the dual-mode touch input apparatus and its user. The FPCB further has a plurality of sensors, is located under the touch pad, and is used for detecting a position of a user touch and issuing a respective detection signal. The function key can be optional and can be activated by clicking the touch pad at a preset location for a predetermined number of times. Alternatively, the function key can be any key on a keyboard of the electronic apparatus that is appropriately programmed. The control chip is used for receiving the detection signal from the FPCB, determining whether the dual-mode touch input apparatus is at the 1-D input mode or the 2-D input mode, and producing a cursor signal in response to the user touch to control movement of a cursor on a screen of the electronic apparatus.

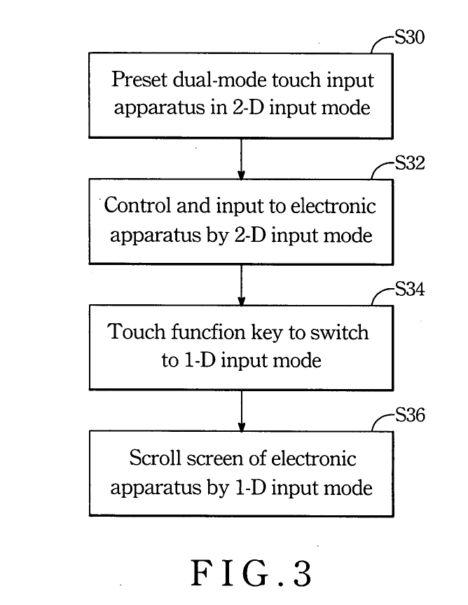

Referring now to FIG. 3, a flowchart of a preferred mode-switching method for the present dual-mode touch input apparatus is shown. As illustrated, the mode-switching method can comprise four major steps; Step S30, Step S32, Step S34 and Step S36. In Step S30, the dual-mode touch input apparatus presets the 2-D input mode as its initial input mode. Namely, the 2-D input mode is the default input mode for the present apparatus. In Step S32, the user can utilize the 2-D input mode to perform operations and inputs to the electronic apparatus.

As described in the background section, while in browsing the web pages or documents, a 2-dimension control method would meet problems in precisely locating the cursor on the scroll control bars or the pop-up message blocks on the screen. Therefore, a switch from a 2-D touch input control to a 1-D one is seemingly desired at this moment. In Step S34, the user touches the function key to switch the input mode from the preset 2-D input mode to the 1-D input mode so as to transform in functions the touch pad into a device resembling the aforesaid touch wheel. Then, in Step S36, the user can scroll the screen of the electronic apparatus by the 1-D input mode. Namely, the user can perform the 1-D input mode on the touch pad, in which the 1-D input mode is appropriate programmed in advance by the manufacturer or the user.

For example, in the 1-D input mode, if the control chip receives a positive direction signal, it will issue a command to have the screen of the electronic apparatus scroll upward. On the other hand, if the control chip receives a negative direction signal, it will issue a respective command to have the screen scroll downward. In the present invention, the positive signal can be defined as a signal generated by circling on the touch pad in a counterclockwise direction, and the negative signal is defined as a signal generated by circling on the touch pad in a clockwise direction. Alternatively, the positive signal can be defined as a signal generated by circling on the touch pad in a clockwise direction, and the negative signal is defined as a signal generated by circling on the touch pad in a counterclockwise direction.

For another example, the positive signal can be defined as a signal generated by moving on the touch pad in an upward direction, while the negative signal is defined as a signal generated by moving on the touch pad in a downward direction. Alternatively, the positive signal can be defined as a signal generated by moving on the touch pad in a downward direction, while the negative signal is defined as a signal generated by moving on the touch pad in an upward direction.

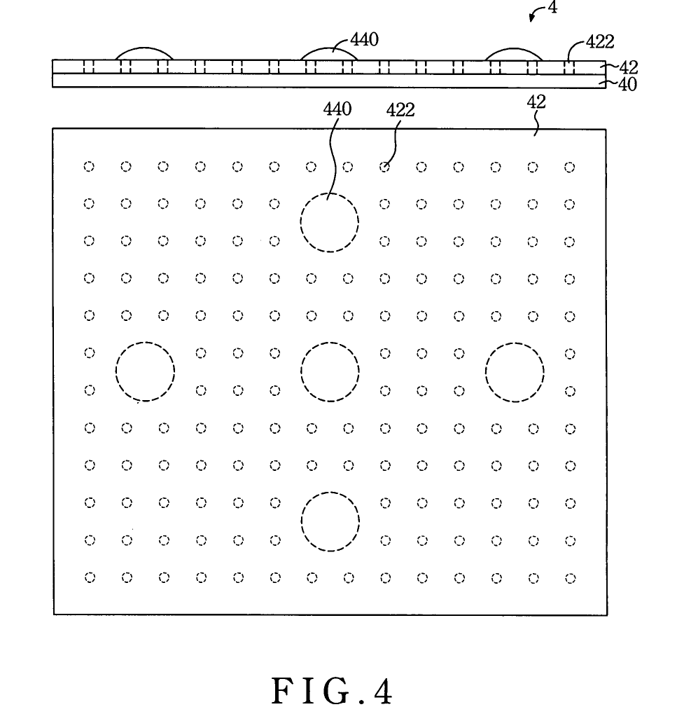

Referring now to FIG. 4, the assembly of the touch pad 40 and the FPCB 42 for the preferred dual-mode touch input apparatus in accordance with the present invention is shown in a front view and a top view. The present apparatus is mounted inside an electronic apparatus (not shown in the figure) that can be a mobile phone, a personal digital assistant, an MP3 player, an input device of a notebook computer, or any the like. As shown, the present apparatus includes a touch module 4 and a plurality of metal domes 440. In the present invention, the touch module 2 can be of a capacitor type, an electromagnetic type, or a resistor type. Details to distinguish these three types are well known to the skill in the art and thus omitted herein.

The touch module 4 includes the touch pad 40 and the FPCB 42. The touch pad 40 as an interface between the dual-mode touch input apparatus and a user can be made of a thermoplastic material (for example, a thermoplastic polyurethane pellet), a transparent material, or a semi-transparent material. The FPCB 42 located under the touch pad 40 can include a plurality of holes 422 and a plurality of sensors (not shown in the figure). Preferably, the plural holes 422 are isolated from and dispersed amid the sensors in a matrix pattern. Practically, each of the holes 422 is a drill hole in the spacing surrounded by the sensors.

The plural metal domes 440 are located under the FPCB 42. Each of the metal domes 440 is in a position corresponding to a specific function key and basically represents a specific function key. In the present invention, according to proper circuiting, the metal domes 440 can be located directly, or in a predetermined spacing to the FPCB 42.

In this embodiment, the user can program properly the touch module 4 into the module that can perform both the 1-D input mode and the 2-D input mode. Further, by providing the metal domes 440, the touch module 4 can provide the user a better touch reaction. In the case that the user depresses upon a specific metal dome 440 (i.e. a corresponding function key), contributed by the plural holes 422, the deflection of the FPCB 42 can only be local; i.e., limited to a small area centered at the depressed metal dome 440. Namely, by introducing the holes 422 to surround each of the sensors, the flexibility of the FPCB 42 as well as the touch pad 40 can be increased. Upon such an arrangement, a depression on a specific metal dome can only deflect a limited area around the current metal dome, and the influence of the depression to other sensors and metal domes can be reduced to a minimum.

In the present invention, the dual-mode touch input apparatus can adopt any specifications of touch pads and touch modules, if and only if the built-in control chip is appropriately upgraded in its driver and initial programs, so that signals generated in the touch pad won't be mis-realized by the control chip. For example, in the 1-D input mode, the control chip can understand that positive/negative signals are to represent upward/downward scrolling of the screen, respectively. Or, in the 2-D input mode, the movement on the touch pad can be well read by the control chip so as to control the cursor on the screen. Also, the function key can transfer clearly the mode-switch signals to the control chip so as to successfully perform the input mode switching.

While the present invention has been particularly shown and described with reference to a preferred embodiment, it will be understood by those skilled in the art that various changes in form and detail may be without departing from the spirit and scope of the present invention.

I claim:

1. A dual-mode touch input apparatus, mounted in an electronic apparatus, having a 1-D input mode and a 2-D input mode, comprising:
a touch pad as an interface between the dual-mode touch input apparatus and a user;
a flexible printed circuit board for detecting a position of a user touch and issuing a detection signal, further having a plurality of sensors and being located under said touch pad; and
a control chip for receiving the detection signal, determining whether the dual-mode touch input apparatus is at the 1-D input mode or the 2-D input mode, and producing a cursor signal in response to the user touch to control movement of a cursor on a screen of the electronic apparatus.

2. The dual-mode touch input apparatus according to claim 1, further including a function key for transmitting a switch signal to said control chip.

3. The dual-mode touch input apparatus according to claim 2, wherein said function key is a key of a keyboard of said electronic apparatus.

4. The dual-mode touch input apparatus according to claim 2, wherein said function key is a key that is activated by clicking said touch pad a predetermined number of times.

5. A mode-switching method for a dual-mode touch input apparatus, the dual-mode touch input apparatus being mounted in an electronic apparatus and further having a touch pad, a flexible printed circuit board (FPCB) and a control chip for determining whether the dual-mode touch input apparatus is at a 1-D input mode or a 2-D input mode, the mode-switching method comprising the steps of:
(a) the FPCB detecting a detection signal and further forwarding the detection signal to the control chip;
(b) the control chip receiving the detection signal and initiating the dual-mode touch input apparatus at the 2-D input mode;
(c) the control chip receiving a switch signal and then switching the dual-mode touch input apparatus to the 1-D input mode;
(d) detecting a direction signal and scrolling upward a screen of the electronic apparatus if the direction signal is a positive signal; and
(e) scrolling downward the screen if the direction signal is a negative signal.

6. The mode-switching method according to claim 5, further including a step of said control chip receiving another switch signal and then switching said dual-mode touch input apparatus back to said 2-D input mode, after said step (c).

7. The mode-switching method according to claim 5, wherein said positive signal is generated by circling on said touch pad in a clockwise direction and said negative signal is generated by circling on said touch pad in a counterclockwise direction.

8. The mode-switching method according to claim 5, wherein said positive signal is generated by circling on said touch pad in a counterclockwise direction and said negative signal is generated by circling on said touch pad in a clockwise direction.

9. The mode-switching method according to claim 5, wherein said positive signal is generated by moving on said touch pad in an upward direction and said negative signal is generated by moving on said touch pad in a downward direction.

10. The mode-switching method according to claim 5, wherein said positive signal is generated by moving on said touch pad in a downward direction and said negative signal is generated by moving on said touch pad in an upward direction.

11. The mode-switching method according to claim 5, wherein said switch signal is generated by clicking said touch pad a predetermined number of times.

12. The mode-switching method according to claim 5, wherein said dual-mode touch input apparatus further includes a function key for generating said switch signal by touching thereupon.

13. The mode-switching method according to claim 12, wherein said function key is a key that is activated by clicking said touch pad a predetermined number of times.
